(19) United States
(12) Patent Application Publication
(10) Pub. No.: US 2010/0083333 A1
(43) Pub. Date: Apr. 1, 2010

(54) Receiver Apparatus and Method

(76) Inventors: Hiroki Mizosoe, Kawasaki (JP); Kazunori Iwabuchi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/491,617

(22) Filed: Jun. 25, 2009

(30) Foreign Application Priority Data
Sep. 26, 2008 (JP) 2008-247088

(51) Int. Cl. H04N 7/173

(52) U.S. Cl. 725/118

(57) ABSTRACT

In a system in which image data and audio data are transmitted and received via a network, a first receiver apparatus transmits its address to a second receiver apparatus, receives an address of the second receiver apparatus from the second receiver apparatus, instructs a first transmitter apparatus which has been associated with the first receiver apparatus to transmit image data and audio data to the received address of the second receiver apparatus, and decodes image data and audio data transmitted from a second transmitter apparatus which has been associated with the second receiver apparatus.

### INCORPORATION BY REFERENCE

The present application claims priority from Japanese application JP2008-247088 filed on Sep. 26, 2008, the content of which is hereby incorporated by reference into this application.

### BACKGROUND OF THE INVENTION

The present invention relates to a receiver apparatus, a transmission/reception system and a reception method.

Various systems allowing a user to communicate media data (audio data, video data, etc.) in real time with the other party at a remote location via a network are in practical use today. Especially, videophone conference systems and VoIP (Voice over IP), realizing the telephone function by executing voice communication via an IP (Internet Protocol) network, have been brought into actual use with the prevalence of the Internet.

As one of protocols for starting a session (connection) between two terminals in order to communicate media data between two sites connected via an IP network, SIP (Session Initiation Protocol) has been established (see RFC3261 (http://www.ietf.org/rfc/rfc3261.txt)) and is widely used today.

### SUMMARY OF THE INVENTION

In SIP, a communication apparatus placed at one site is generally equipped with both the functions of transmitting and receiving media data (video data, audio data, etc.). For example, an IP telephone set has both the functions of transmitting and receiving voice data (audio data). In such cases, as long as one address capable of uniquely specifying or identifying a telephone set on a network (e.g. IP address) is assigned to each IP telephone set, the address may be used for the identification of each IP telephone set irrespective of whether the IP telephone set is used as a calling end (caller) or a receiving end (callee). Incidentally, the “address” used here is not restricted to an IP address; the “address” may include any identifier capable of uniquely specifying the destination of the connection to the apparatus, such as a URI (Uniform Resource Identifier) and a related port number.

Based on the above consideration, protocols (even SIP) have been designed on the assumption that each site executing communication uses only one address for the transmission and reception of media data.

Meanwhile, audio-visual devices (TV, video camera, etc.) are being progressively equipped with the network compatibility in recent years and such network-compatible devices are allowing the users to send and enjoy media data (video data, audio data, etc.) via a network.

For example, it is possible to use a network-compatible TV (television set) as a media data receiver apparatus and a network-compatible video camera as a media data transmitter apparatus. By combining the network-compatible TV with the network-compatible video camera and using them as a communication system, the TV and the video camera may be used as if they were a media data transceiver (transmitter/receiver) apparatus placed at an site. In such cases, different network addresses have been assigned to the TV and the video camera since they are independent devices.

However, it is sometimes impossible to start communication by use of the conventional session starting protocols (as typified by SIP) since the protocols have been designed without considering the aforementioned cases where the media data transmitter apparatus and the media data receiver apparatus have different addresses.

To resolve the above problem, in accordance with an aspect of the present invention, there is provided a receiver apparatus for receiving image data (still image data or video data, ditto for the following description) and audio data via a network, comprising a decoding unit which decodes received image data and audio data, an image output unit which outputs the image data decoded by the decoding unit, an audio output unit which outputs the audio data decoded by the decoding unit, a recording unit which records an address of a transmitter apparatus that has been associated with the receiver apparatus, and a control unit which instructs the transmitter apparatus associated with the receiver apparatus to transmit data to an address of a different receiver apparatus when the address of the different receiver apparatus is received.

In accordance with another aspect of the present invention, there is provided a transmission/reception system in which a first receiver apparatus, a first transmitter apparatus which has been associated with the first receiver apparatus, a second receiver apparatus and a second transmitter apparatus which has been associated with the second receiver apparatus are connected together by a network. In the transmission/reception system, each of the first and second receiver apparatuses includes a decoding unit which decodes received image data and audio data, an image output unit which outputs the image data decoded by the decoding unit, an audio output unit which outputs the audio data decoded by the decoding unit, a recording unit which records an address of the transmitter apparatus associated with the receiver apparatus, and a control unit which controls the receiver apparatus. Each of the first and second transmitter apparatuses includes an encoding unit which encodes images and sound a control unit which controls the transmitter apparatus. The control unit of the second receiver apparatus transmits an address of the second receiver apparatus to the first receiver apparatus when an address of the first receiver apparatus is received by the second receiver apparatus. The control unit of the first receiver apparatus receiving the address of the second receiver apparatus instructs the first transmitter apparatus to transmit image data and audio data to the address of the second receiver apparatus. The first transmitter apparatus receiving the instruction from the control unit of the first receiver apparatus transmits image data and audio data obtained by the encoding by the encoding unit of the first transmitter apparatus to the second receiver apparatus. The control unit of the second receiver apparatus instructs the second transmitter apparatus to transmit image data and audio data to the address of the first receiver apparatus received from the first receiver apparatus. The second transmitter apparatus receiving the instruction from the control unit of the second receiver apparatus transmits image data and audio data obtained by the encoding by the encoding unit of the second transmitter apparatus to the first receiver apparatus.

In accordance with another aspect of the present invention, there is provided a reception method for a receiver apparatus for receiving image data and audio data via a network. The reception method comprises the steps of transmitting an address of the receiver apparatus to a second receiver apparatus, receiving an address of the second receiver apparatus from the second receiver apparatus, instructing a first transmitter apparatus which has been associated with the receiver apparatus to transmit image data and audio data to the received address of the second receiver apparatus, and decoding image data and audio data transmitted from a second transmitter apparatus which has been associated with the second receiver apparatus.

With the above receiver apparatus, transmission/reception system and reception method, communication between sites may be started normally even when a media data transmitter apparatus and a media data receiver apparatus in an site have different addresses.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram showing an example of a procedure for starting a session in accordance with a first embodiment of the present invention.

FIG. 2 is a schematic diagram showing a media data communication system in accordance with the first embodiment.

FIG. 3 is a schematic diagram showing an example of a procedure for disconnecting a session in accordance with the first embodiment.

FIG. 4 is a schematic diagram showing a media data communication system in accordance with a second embodiment of the present invention.

FIG. 5 is a schematic diagram showing an example of a procedure for starting a session in accordance with the second embodiment.

FIG. 6 is a schematic diagram showing another example of a procedure for starting a session in accordance with the second embodiment.

FIG. 7 is a schematic diagram showing an example of a procedure for disconnecting a session in accordance with the second embodiment.

FIG. 8 is a schematic diagram showing another example of a procedure for disconnecting a session in accordance with the second embodiment.

FIG. 9 is a schematic diagram showing an example of a procedure for starting a session in accordance with a third embodiment of the present invention.

FIG. 10 is a schematic diagram showing an example of a procedure for starting a session in accordance with a fourth embodiment of the present invention.

FIG. 11 is a block diagram showing an example of the configuration of a receiver apparatus included in the media data communication system of FIG. 2.

FIG. 12 is a block diagram showing an example of the configuration of a transmitter apparatus included in the media data communication system of FIG. 2.

FIG. 13 is a block diagram showing an example of the configuration of a transceiver apparatus included in the media data communication system of FIG. 4.

### DESCRIPTION OF THE EMBODIMENTS

Referring now to the drawings, a description will be given in detail of preferred embodiments in accordance with the present invention.

### Embodiment 1

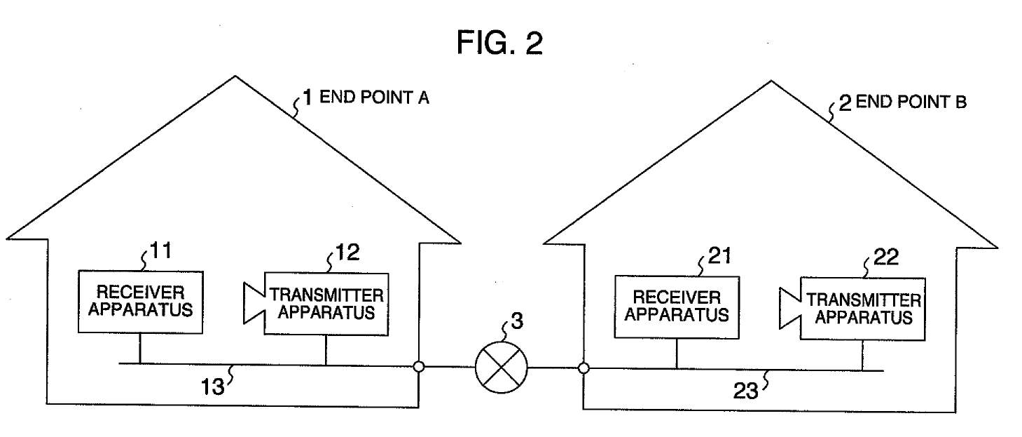

FIG. 2 is a schematic diagram showing a media data communication system for transmitting and receiving media data (video data (or image data) and audio data) in accordance with a first embodiment of the present invention. The media data communication system shown in FIG. 2 includes two sites A and B.

The site A is equipped with a TV (television set) as a receiver apparatus 11 and a video camera as a transmitter apparatus 12. The receiver apparatus 11 and the transmitter apparatus 12 are connected with each other by a network 13. Addresses A1 and A2 have been assigned to the receiver apparatus 11 and the transmitter apparatus 12, respectively.

Similarly, the site B is equipped with a TV as a receiver apparatus 21 and a video camera as a transmitter apparatus 22. The receiver apparatus 21 and the transmitter apparatus 22 are connected with each other by a network 23. Addresses B1 and B2 have been assigned to the receiver apparatus 21 and the transmitter apparatus 22, respectively.

Further, the network 13 of the site A and the network 23 of the site B are connected with each other via a network 3.

Before executing communication, a grouping setting (for grouping the apparatuses) is made in each site. In the site A, for example, the address A1 of the receiver apparatus 11 is registered in the transmitter apparatus 12 and the address A2 of the transmitter apparatus 12 is registered in the receiver apparatus 11, by which the apparatuses 11 and 12 are allowed to recognize each other as apparatuses that have been associated in the same site. The grouping setting is also made for the receiver apparatus 21 and the transmitter apparatus 22 in the site B in a similar way.

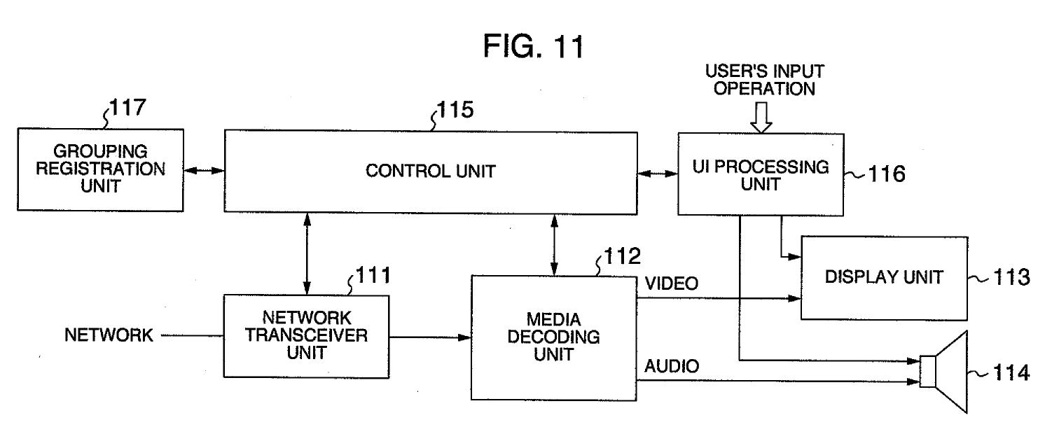

Next, the configuration of each receiver apparatus (11, 21) will be described. FIG. 11 is a block diagram showing an example of the configuration of the receiver apparatus (11, 21). The receiver apparatus (11, 21) includes a network transceiver unit 111, a media decoding unit 112, a display unit 113, a speaker 114, a control unit 115, a UI processing unit 116 and a grouping registration unit 117.

The network transceiver unit 111, which is connected to the network outside the receiver apparatus (11, 21), carries out the transmission and reception of messages and media data according to instructions from the control unit 115. The media data received by the network transceiver unit 111 is supplied to the media decoding unit 112.

The media decoding unit 112 receives the media data from the network transceiver unit 111 and executes an audio/video decoding process to the media data according to instructions from the control unit 115. Video data obtained by the decoding by the media decoding unit 112 is displayed by the display unit 113, while audio data obtained by the decoding by the media decoding unit 112 is outputted by the speaker 114.

The control unit 115, which manages state transitions necessary for the communication process, controls the operations of the network transceiver unit 111, the media decoding unit 112 and the UI processing unit 116.

The control unit 115 creates a message to be sent to an external apparatus and transmits the created message via the network transceiver unit 111. The control unit 115 also receives a message from an external apparatus via the network transceiver unit 111, interprets the received message and executes the aforementioned control based on the contents of the message.

The UI processing unit 116 executes processes for implementing a user interface. Specifically, the UI processing unit 116 receives the user's input operations for call origination, disconnection, call reception, etc. and informs the control unit 115 about the user operations, while giving necessary notifications (e.g. about an incoming call) to the user via the display unit 113 and/or the speaker 114 according to instructions from the control unit 115.

The grouping registration unit 117 holds the address of each transmitter apparatus for which the grouping setting has been made in the site (A, B). In this embodiment, the address A2 of the transmitter apparatus 12 is registered in the grouping registration unit 117 of the receiver apparatus 11 in the site A, while the address B2 of the transmitter apparatus 22 is registered in the grouping registration unit 117 of the receiver apparatus 21 in the site B. The registered address of each transmitter apparatus is outputted to the control unit 115 as needed.

Incidentally, the receiver apparatus (11, 21) does not necessarily have to include the display unit 113 and the speaker 114; the receiver apparatus (11, 21) may also be configured to output the video data and the audio data to an external display device and an external speaker.

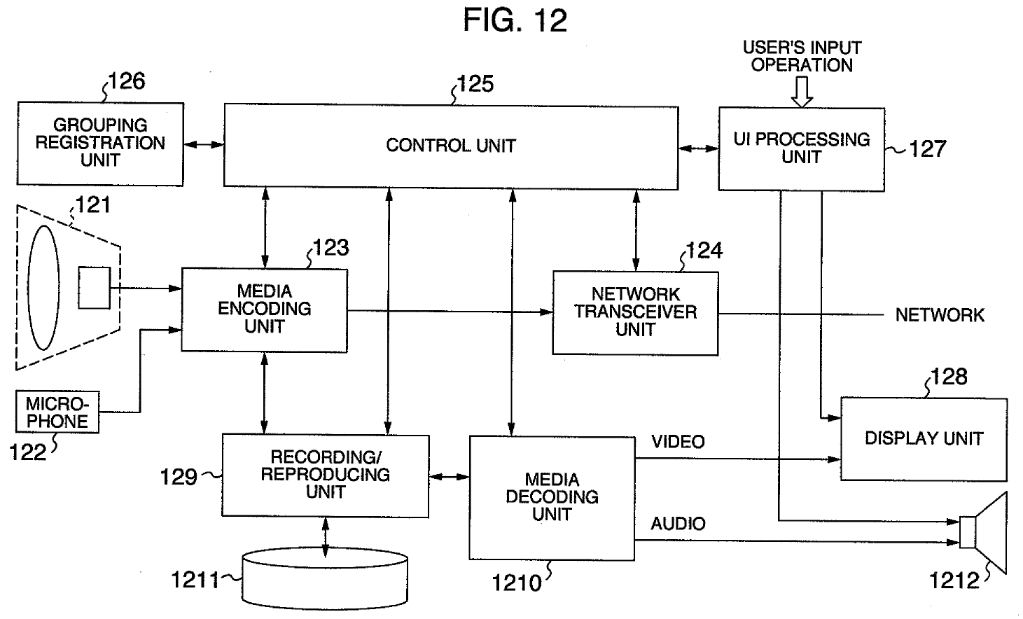

Next, the configuration of each transmitter apparatus (12, 22) will be described. FIG. 12 is a block diagram showing an example of the configuration of the transmitter apparatus (12, 22). The transmitter apparatus (12, 22) includes an imaging processing unit 121, a microphone 122, a media encoding unit 123, a network transceiver unit 124, a control unit 125, a grouping registration unit 126, a UI processing unit 127, a display unit 128, a recording/reproducing unit 129, a media decoding unit 1210, a record medium 1211 and a speaker 1212.

The imaging processing unit 121 (including a lens and an image pickup device) captures video and outputs a corresponding video signal to the media encoding unit 123. The microphone 122 picks up sound (voice) and outputs a corresponding audio signal to the media encoding unit 123.

The media encoding unit 123 receives the video signal and the audio signal from the imaging processing unit 121 and the microphone 122, respectively, and encodes the audio/video signals into media data according to instructions from the control unit 125. The media data obtained by the encoding is sent to the network transceiver unit 124.

The network transceiver unit 124, which is connected to the network outside the transmitter apparatus (12, 22), carries out the transmission and reception of messages and media data according to instructions from the control unit 125. The media data received from the media encoding unit 123 is transmitted to the network via the network transceiver unit 124.

The control unit 125, which manages state transitions necessary for the communication process, controls the operations of the network transceiver unit 124 and the media encoding unit 123.

Further, the control unit 125 creates a message to be sent to an external apparatus and transmits the created message via the network transceiver unit 124. The control unit 125 also receives a message from an external apparatus via the network transceiver unit 124, interprets the received message and executes the aforementioned control based on the contents of the message.

The grouping registration unit 126 holds the address of each receiver apparatus for which the grouping setting has been made in the site (A, B). In this embodiment, the address A1 of the receiver apparatus 11 is registered in the grouping registration unit 126 of the transmitter apparatus 12 in the site A, while the address B1 of the receiver apparatus 21 is registered in the grouping registration unit 126 of the transmitter apparatus 22 in the site B. The registered address of each receiver apparatus is outputted to the control unit 125 as needed.

Incidentally, the transmitter apparatus (12, 22), having also the video camera function, is capable of recording and reproducing captured video and sound (voice). The operation of the transmitter apparatus (12, 22) for the audio/video recording/reproduction will be described below.

For the recording of video, the UI processing unit 127 receives the user's instruction for starting the recording and then informs the control unit 125 of the contents of the instruction. Based on the information from the UI processing unit 127, the control unit 125 issues instructions for the video recording to the media encoding unit 123 and the recording/reproducing unit 129.

The media encoding unit 123 sends the encoded media data to the recording/reproducing unit 129 according to instructions from the control unit 125. The recording/reproducing unit 129 receiving the media data from the media encoding unit 123 records the media data on the record medium 1211 according to instructions from the control unit 125.

For the reproduction of the video (media data) recorded on the record medium 1211, the UI processing unit 127 receives the user's instruction for starting the reproduction and then informs the control unit 125 of the contents of the instruction. Based on the information from the UI processing unit 127, the control unit 125 issues instructions for the video reproduction to the recording/reproducing unit 129 and the media decoding unit 1210.

The recording/reproducing unit 129 reads out the recorded media data from the record medium 1211 according to instructions from the control unit 125 and sends the obtained media data to the media decoding unit 1210. The media decoding unit 1210 receiving the media data from the recording/reproducing unit 129 executes an audio/video decoding process according to instructions from the control unit 125. Video obtained by the decoding by the media decoding unit 1210 is displayed by the display unit 128, while sound (voice) obtained by the decoding by the media decoding unit 1210 is outputted by the speaker 1212.

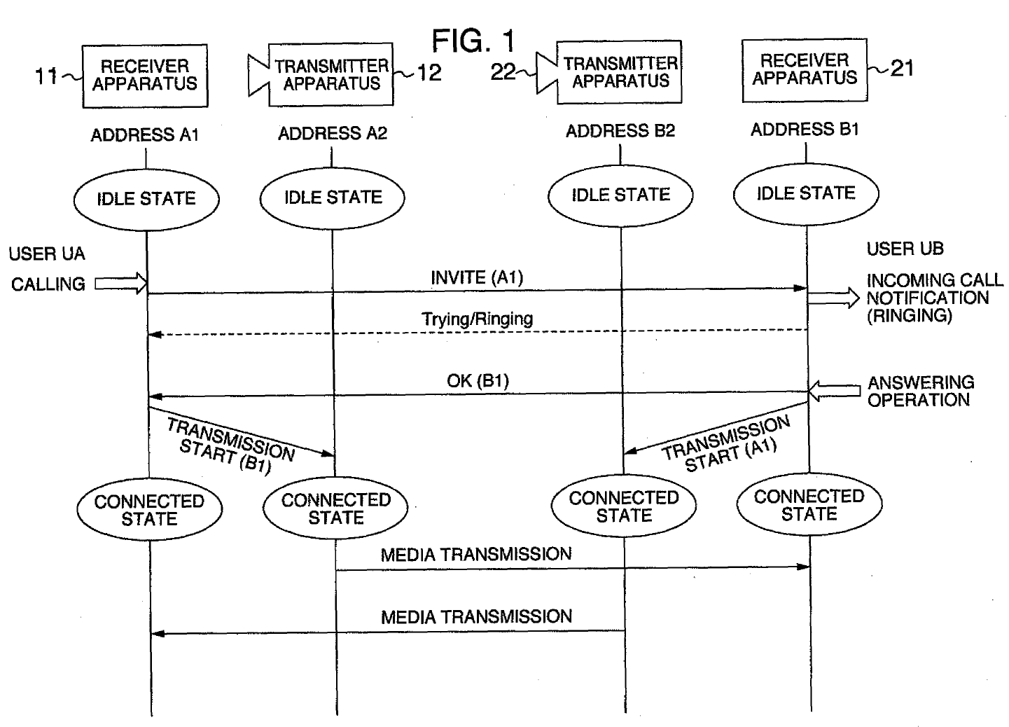

Next, a procedure for starting a session in accordance with this embodiment will be explained below referring to FIG. 1, wherein the sites A and B are assumed to operate as a calling end (caller) and a receiving end (callee), respectively. The process shown in FIG. 1 is implemented by the control of the components of each receiver apparatus (11, 21) by its control unit 115 and the control of the components of each transmitter apparatus (12, 22) by its control unit 125.

Before starting communication, each apparatus (11, 12, 21, 22) is in an “IDLE state” (standby state).

The user UA of the site A performs a calling operation on the receiver apparatus 11 (TV) by specifying the address B1 as the destination of the call (callee). In response to the user UA's calling operation, the receiver apparatus 11 of the site A transmits an INVITE message (requesting starting of communication) to the receiver apparatus 21 of the site B. The INVITE message sent from the receiver apparatus 11 contains address information (A1) on the receiver apparatus 11 as the recipient address (address of the recipient of media data in the site A (caller)).

The receiver apparatus 21 of the site B receives the INVITE message and thereby recognizes the communication start request from the site A. In response to the request, the receiver apparatus 21 notifies the site B's user UB of the incoming call and prompts the user UB to answer the call, by making a sound, displaying information on its screen, etc.

At this point, the receiver apparatus 21 may also transmit a TRYING message or RINGING message (indicating that the receiver apparatus 21 is ringing) to the receiver apparatus 11. In this case, the receiver apparatus 11 receiving the TRYING or RINGING message may inform the user UA that the receiver apparatus 11 is making a call (by making a sound, displaying information on its screen, etc.).

When the user UB of the site B permits the call reception by performing an answering operation, the receiver apparatus 21 shifts to a “CONNECTED state” and transmits an OK message (acknowledging the call reception) to the receiver apparatus 11. The OK message sent from the receiver apparatus 21 contains address information (B1) on the receiver apparatus 21 as the recipient address (address of the recipient of media data in the site B (callee)).

Further, the receiver apparatus 21 issues a transmission start instruction (instruction for starting the transmission of media data) to the transmitter apparatus 22. The transmission start instruction issued by the receiver apparatus 21 contains the address information A1 on the receiver apparatus 11 (destination of the media data). Incidentally, while the receiver apparatus 21 issues the media data transmission start instruction to the transmitter apparatus 22 after the transmission of the OK message to the receiver apparatus 11 (caused by the user's answering operation) in the example of FIG. 1, the receiver apparatus 21 may also be configured to issue the transmission start instruction to the transmitter apparatus 22 before or at the same time as the transmission of the OK message to the receiver apparatus 11.

Upon reception of the OK message from the receiver apparatus 21, the receiver apparatus 11 shifts to the “CONNECTED state” and issues the transmission start instruction (instruction for starting the transmission of media data) to the transmitter apparatus 12. The transmission start instruction issued by the receiver apparatus 11 contains the address information B1 on the receiver apparatus 21 (destination of the media data).

In response to the media data transmission start instruction from the receiver apparatus 11, the transmitter apparatus 12 shifts to the CONNECTED state, captures video and sound (voice) with its built-in camera and microphone, and starts transmitting encoded media data (obtained by encoding the captured video and sound) to the address B1 (receiver apparatus 21).

The receiver apparatus 21 receives the media data transmitted from the transmitter apparatus 12 and outputs video and sound (voice) obtained by decoding the received media data.

Meanwhile, in response to the media data transmission start instruction from the receiver apparatus 21, the transmitter apparatus 22 shifts to the CONNECTED state, captures video and sound (voice) with its built-in camera and microphone, and starts transmitting encoded media data (obtained by encoding the captured video and sound) to the address A1 (receiver apparatus 11).

The receiver apparatus 11 receives the media data transmitted from the transmitter apparatus 22 and outputs video and sound (voice) obtained by decoding the received media data.

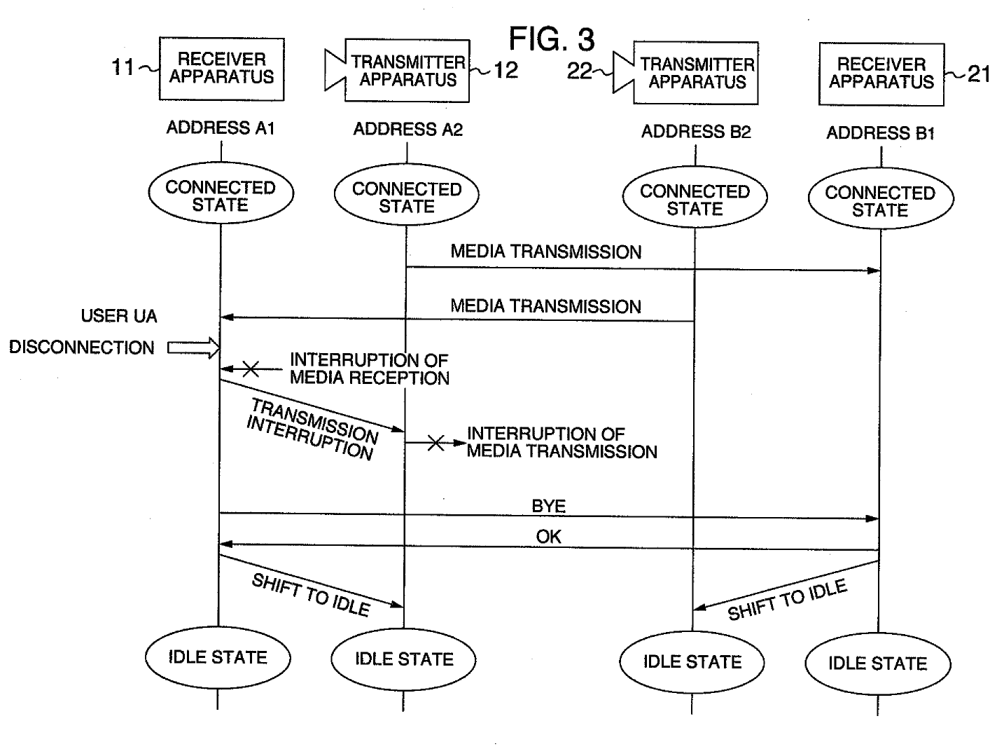

Next, a procedure for disconnecting a session in accordance with this embodiment will be explained below referring to FIG. 3. The process shown in FIG. 3 is implemented by the control of the components of each receiver apparatus (11, 21) by its control unit 115 and the control of the components of each transmitter apparatus (12, 22) by its control unit 125.

In FIG. 3, a session has already been started and each apparatus (11, 12, 21, 22) is in the CONNECTED state. At this point, the user UA of the site A performs a communication disconnecting operation on the receiver apparatus 11.

In response to the operation by the user UA, the receiver apparatus 11 interrupts the media data reception from the transmitter apparatus 22 while also issuing a transmission interrupting instruction (instruction for interrupting the media data transmission) to the transmitter apparatus 12.

In response to the media data transmission interrupting instruction from the receiver apparatus 11, the transmitter apparatus 12 stops the media data transmission to the receiver apparatus 21.

Further, the receiver apparatus 11 transmits a BYE message (requesting the disconnection of the session) to the receiver apparatus 21.

Incidentally, while the receiver apparatus 11 interrupts the media data transmission from the transmitter apparatus 22, issues the media data transmission interrupting instruction to the transmitter apparatus 12, and thereafter transmits the BYE message to the receiver apparatus 21 in the example of FIG. 3, the three steps may also executed in a different order or at the same time.

Upon reception of the BYE message from the receiver apparatus 11, the receiver apparatus 21 shifts to the “IDLE state” and instructs the transmitter apparatus 22 to shift to the IDLE state. Incidentally, while the receiver apparatus 21 in this example shifts to the IDLE state before instructing the transmitter apparatus 22 to shift to the IDLE state, the receiver apparatus 21 may also be configured to shift to the IDLE state after or at the same as the instruction to the transmitter apparatus 22.

In response to the instruction (to shift to the IDLE state) from the receiver apparatus 21, the transmitter apparatus 22 shifts to the IDLE state and transmits an OK message (acknowledging the disconnection) to the receiver apparatus 11.

Upon reception of the OK message from the receiver apparatus 21, the receiver apparatus 11 shifts to the IDLE state and instructs the transmitter apparatus 12 to shift to the IDLE state. The receiver apparatus 11 may also be configured to shift to the IDLE state after or at the same as the instruction to the transmitter apparatus 12.

In response to the instruction (to shift to the IDLE state) from the receiver apparatus 11, the transmitter apparatus 12 shifts to the IDLE state.

Incidentally, while the disconnection is made from the site A in the example of FIG. 3, the disconnection may also be made from the site B in a similar way (except that the sites A and B operate reversely).

As described above, with the first embodiment, a session for transmitting and receiving media data may be started and/or disconnected by use of multiple pieces of apparatus having different addresses (A1, A2, B1, B2). Further, consistency may be given to the state transitions of the apparatuses between the IDLE state and the CONNECTED state, by which the starting and the disconnection of the communication may be executed normally.

Incidentally, while both video data and audio data are encoded and transmitted/received as media data in this embodiment, the media data may also be made up of video data only or audio data only. Further, the procedure of this embodiment may also be employed similarly for the transmission/reception of data other than video data or audio data.

### Embodiment 2

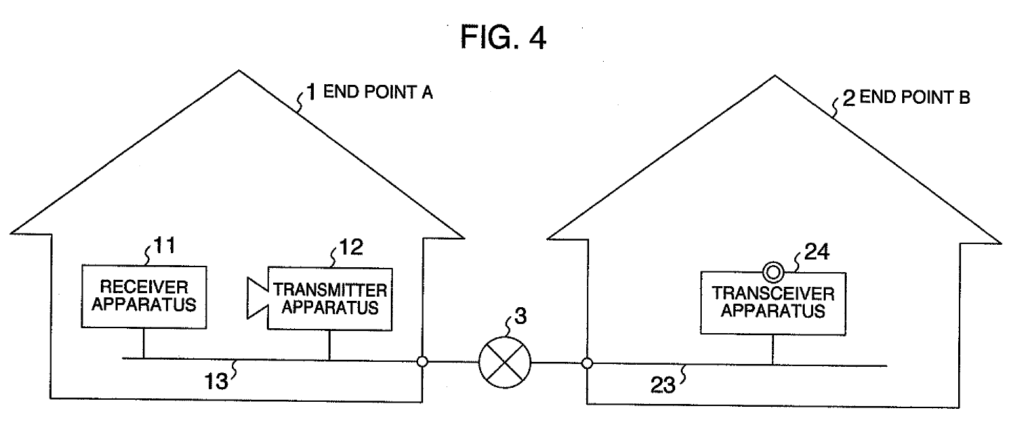

In the following, a second embodiment in accordance with the present invention will be described in detail, wherein explanation of elements similar to those in the first embodiment will be omitted for brevity. FIG. 4 is a schematic diagram showing a media data communication system for transmitting and receiving audio/video media data in accordance with the second embodiment. The difference from the first embodiment is the configuration of the site B. In the site B in the second embodiment, the functions of transmitting and receiving media data are implemented by a single apparatus (transceiver apparatus 24). The transceiver apparatus 24, to which an address B1 has been assigned, is connected to a home network 23.

Further, the network 13 of the site A and the network 23 of the site B are connected with each other via a network 3.

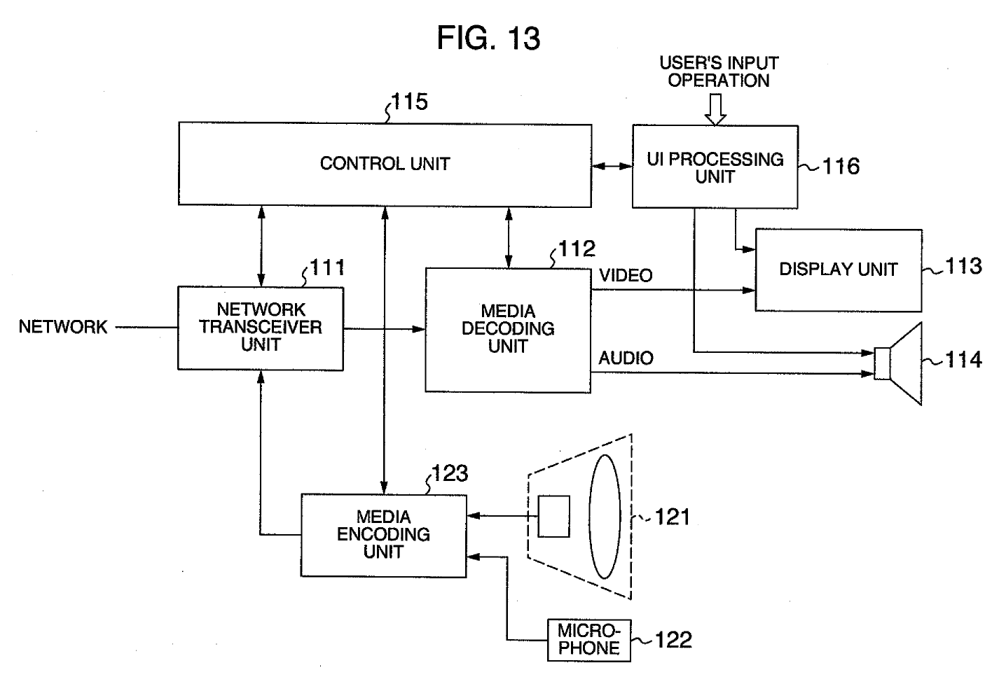

Next, the configuration of the transceiver apparatus 24 will be described. FIG. 13 is a block diagram showing an example of the configuration of the transceiver apparatus 24. The transceiver apparatus 24 includes a network transceiver unit 111, a media decoding unit 112, a display unit 113, a speaker 114, a control unit 115, a UI processing unit 116, a grouping registration unit 117, an imaging processing unit 121, a microphone 122 and a media encoding unit 123.

The transceiver apparatus 24 is an apparatus having both the media data reception function (of the receiver apparatuses (11, 21) in the first embodiment) and the media data transmission function (of the transmitter apparatus (12, 22) in the first embodiment). The operation of the transceiver apparatus 24 for receiving media data is identical with that of the receiver apparatus 11 which has been explained in the first embodiment, and thus repeated explanation thereof is omitted for brevity.

Next, the operation of the transceiver apparatus 24 for transmitting media data will be described below.

The imaging processing unit 121 (including a lens and an image pickup device) captures video and outputs a corresponding video signal to the media encoding unit 123. The microphone 122 picks up sound (voice) and outputs a corresponding audio signal to the media encoding unit 123.

The media encoding unit 123 receives the video signal and the audio signal from the imaging processing unit 121 and the microphone 122, respectively, and encodes the audio/video signals into media data according to instructions from the control unit 115. The media data obtained by the encoding is sent to the network transceiver unit 111.

The network transceiver unit 111, which is connected to the network outside the transceiver apparatus 24, carries out the transmission and reception of messages and media data according to instructions from the control unit 115. The media data received from the media encoding unit 123 is transmitted to the network via the network transceiver unit 111.

The control unit 115, which manages state transitions necessary for the communication process, controls the operations of the network transceiver unit 111 and the media encoding unit 123.

Further, the control unit 115 creates a message to be sent to an external apparatus and transmits the created message via the network transceiver unit 111. The control unit 115 also receives a message from an external apparatus via the network transceiver unit 111, interprets the received message and executes the aforementioned control based on the contents of the message.

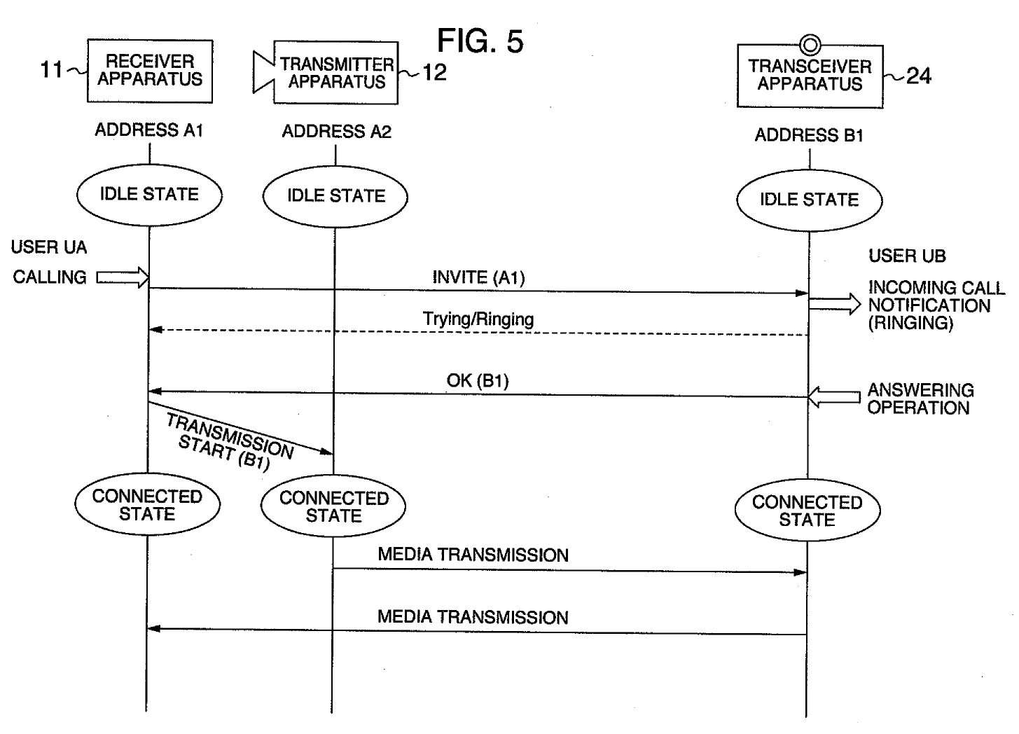

Next, a procedure for starting a session in accordance with this embodiment will be explained below referring to FIG. 5, wherein the sites A and B are assumed to operate as a calling end (caller) and a receiving end (callee), respectively. The process shown in FIG. 5 is implemented by the control of the components of the receiver apparatus 11 by its control unit 115, the control of the components of the transmitter apparatus 12 by its control unit 125 and the control of the components of the transceiver apparatus 24 by its control unit 115.

Before starting communication, each apparatus (11, 12, 24) is in the IDLE state (standby state).

The user UA of the site A performs the calling operation on the receiver apparatus 11 (TV) by specifying the address B1 as the destination of the call (callee). In response to the user UA's calling operation, the receiver apparatus 11 of the site A transmits the INVITE message (requesting starting of communication) to the transceiver apparatus 24 of the site B. The INVITE message sent from the receiver apparatus 11 contains address information (A1) on the receiver apparatus 11 as the recipient address (address of the recipient of media data in the site A (caller)).

The transceiver apparatus 24 of the site B receives the INVITE message and thereby recognizes the communication start request from the site A. In response to the request, the transceiver apparatus 24 notifies the site B's user UB of the incoming call and prompts the user UB to answer the call, by making a sound, displaying information on its screen, etc.

When the user UB of the site B permits the call reception by performing the answering operation, the transceiver apparatus 24 shifts to the CONNECTED state and transmits the OK message (acknowledging the call reception) to the receiver apparatus 11. The OK message sent from the transceiver apparatus 24 contains address information (B1) on the transceiver apparatus 24 as the recipient address (address of the recipient of media data in the site B (callee)). Incidentally, the transceiver apparatus 24 may also be configured to shift to the CONNECTED state after or at the same time as the transmission of the OK message to the receiver apparatus 11.

Upon reception of the OK message from the transceiver apparatus 24, the receiver apparatus 11 shifts to the CONNECTED state and issues the transmission start instruction (instruction for starting the transmission of media data) to the transmitter apparatus 12. The transmission start instruction issued by the receiver apparatus 11 contains the address information B1 on the transceiver apparatus 24 (destination of the media data). Incidentally, the receiver apparatus 11 may also be configured to shift to the CONNECTED state after or at the same time as the issuance of the transmission start instruction to the transmitter apparatus 12.

In response to the media data transmission start instruction from the receiver apparatus 11, the transmitter apparatus 12 shifts to the CONNECTED state, captures video and sound (voice) with its built-in camera and microphone, and starts transmitting encoded media data (obtained by encoding the captured video and sound) to the address B1 (transceiver apparatus 24).

The transceiver apparatus 24 receives the media data transmitted from the transmitter apparatus 12 and outputs video and sound (voice) obtained by decoding the received media data.

Further, the transceiver apparatus 24 captures video and sound (voice) with its built-in camera and microphone and starts transmitting encoded media data (obtained by encoding the captured video and sound) to the address A1 (receiver apparatus 11). Incidentally, the transceiver apparatus 24 may also be configured to start the transmission of the media data to the receiver apparatus 11 before or at the same time as the reception of media data from the transmitter apparatus 12.

The receiver apparatus 11 receives the media data transmitted from the transceiver apparatus 24 and outputs video and sound (voice) obtained by decoding the received media data.

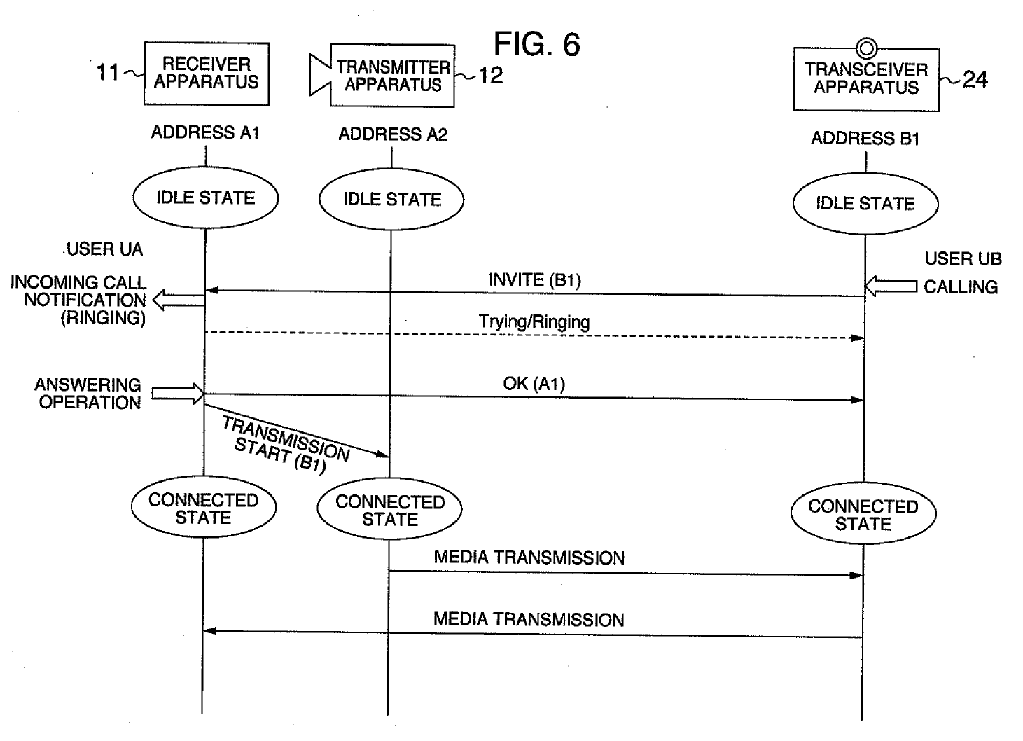

Next, a procedure in accordance with this embodiment for starting a session from the site B (a case where the sites A and B operate as a receiving end (callee) and a calling end (caller), respectively) will be explained below referring to FIG. 6. The process shown in FIG. 6 is implemented by the control of the components of the receiver apparatus 11 by its control unit 115, the control of the components of the transmitter apparatus 12 by its control unit 125 and the control of the components of the transceiver apparatus 24 by its control unit 115.

Before starting communication, each apparatus (11, 12, 24) is in the IDLE state (standby state).

The user UB of the site B performs the calling operation on the transceiver apparatus 24 by specifying the address A1 as the destination of the call (callee). In response to the user UB's calling operation, the transceiver apparatus 24 of the site B transmits the INVITE message (requesting starting of communication) to the receiver apparatus 11 of the site A. The INVITE message sent from the transceiver apparatus 24 contains address information (B1) on the transceiver apparatus 24 as the recipient address (address of the recipient of media data in the site B (caller)).

The receiver apparatus 11 of the site A receives the INVITE message and thereby recognizes the communication start request from the site B. In response to the request, the receiver apparatus 11 notifies the site A's user UA of the incoming call and prompts the user UA to answer the call, by making a sound, displaying information on its screen, etc.

When the user UA of the site A permits the call reception by performing the answering operation, the receiver apparatus 11 shifts to the CONNECTED state and transmits the OK message (acknowledging the call reception) to the transceiver apparatus 24. The OK message sent from the receiver apparatus 11 contains address information (A1) on the receiver apparatus 11 as the recipient address (address of the recipient of media data in the site A (callee)).

Further, the receiver apparatus 11 issues the transmission start instruction (instruction for starting the transmission of media data) to the transmitter apparatus 12. The transmission start instruction issued by the receiver apparatus 11 contains the address information B1 on the transceiver apparatus 24 (destination of the media data). Incidentally, the receiver apparatus 11 may also be configured to carry out the shift to the CONNECTED state, the transmission of the OK message to the transceiver apparatus 24 and the issuance of the transmission start instruction to the transmitter apparatus 12 in a different order (or at the same time).

Upon reception of the OK message from the receiver apparatus 11, the transceiver apparatus 24 shifts to the CONNECTED state, captures video and sound (voice) with its built-in camera and microphone, and starts transmitting encoded media data (obtained by encoding the captured video and sound) to the address A1 (receiver apparatus 11). The transceiver apparatus 24 may also be configured to start the transmission of the media data to the receiver apparatus 11 before or at the same time as the shift to the CONNECTED state.

The receiver apparatus 11 receives the media data transmitted from the transceiver apparatus 24 and outputs video and sound (voice) obtained by decoding the received media data.

In response to the media data transmission start instruction from the receiver apparatus 11, the transmitter apparatus 12 shifts to the CONNECTED state, captures video and sound (voice) with its built-in camera and microphone, and starts transmitting encoded media data (obtained by encoding the captured video and sound) to the address B1 (transceiver apparatus 24). The transmitter apparatus 12 may also be configured to start the transmission of the media data to the transceiver apparatus 24 before or at the same time as the shift to the CONNECTED state.

Incidentally, while the media data transmission from the transceiver apparatus 24 to the receiver apparatus 11 is carried out after the media data transmission from the transmitter apparatus 12 to the transceiver apparatus 24 in the example of FIG. 6, the two transmission processes may be executed in a different order or at the same time.

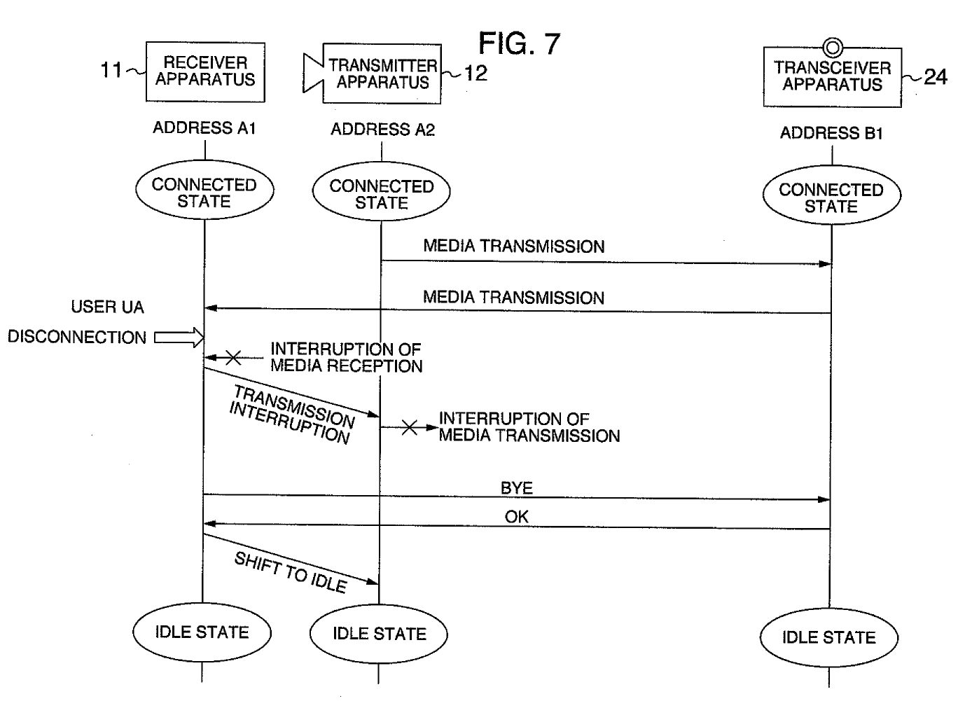

Next, a procedure for disconnecting a session in accordance with this embodiment will be explained below referring to FIG. 7. The process shown in FIG. 7 is implemented by the control of the components of the receiver apparatus 11 by its control unit 115, the control of the components of the transmitter apparatus 12 by its control unit 125 and the control of the components of the transceiver apparatus 24 by its control unit 115.

In FIG. 7, a session has already been started and each apparatus (11, 12, 24) is in the CONNECTED state. At this point, the user UA of the site A performs the communication disconnecting operation on the receiver apparatus 11.

In response to the operation by the user UA, the receiver apparatus 11 interrupts the media data reception from the transceiver apparatus 24 while also issuing the transmission interrupting instruction (instruction for interrupting the media data transmission) to the transmitter apparatus 12.

In response to the media data transmission interrupting instruction from the receiver apparatus 11, the transmitter apparatus 12 stops the media data transmission to the transceiver apparatus 24. Further, the receiver apparatus 11 transmits the BYE message (requesting the disconnection of the session) to the transceiver apparatus 24. Incidentally, the stoppage of the media data transmission to the transceiver apparatus 24 (by the transmitter apparatus 12) and the transmission of the BYE message to the transceiver apparatus 24 (by the receiver apparatus 11) may also be executed in a different order or at the same time.

Upon reception of the BYE message from the receiver apparatus 11, the transceiver apparatus 24 shifts to the IDLE state and transmits the OK message (acknowledging the disconnection) to the receiver apparatus 11. The transceiver apparatus 24 may also be configured to transmit the OK message (acknowledging the disconnection) before or at the same time as the shift to the IDLE state.

Upon reception of the OK message from the transceiver apparatus 24, the receiver apparatus 11 shifts to the IDLE state and instructs the transmitter apparatus 12 to shift to the IDLE state. The receiver apparatus 11 may also be configured to shift to the IDLE state after or at the same as the instruction to the transmitter apparatus 12.

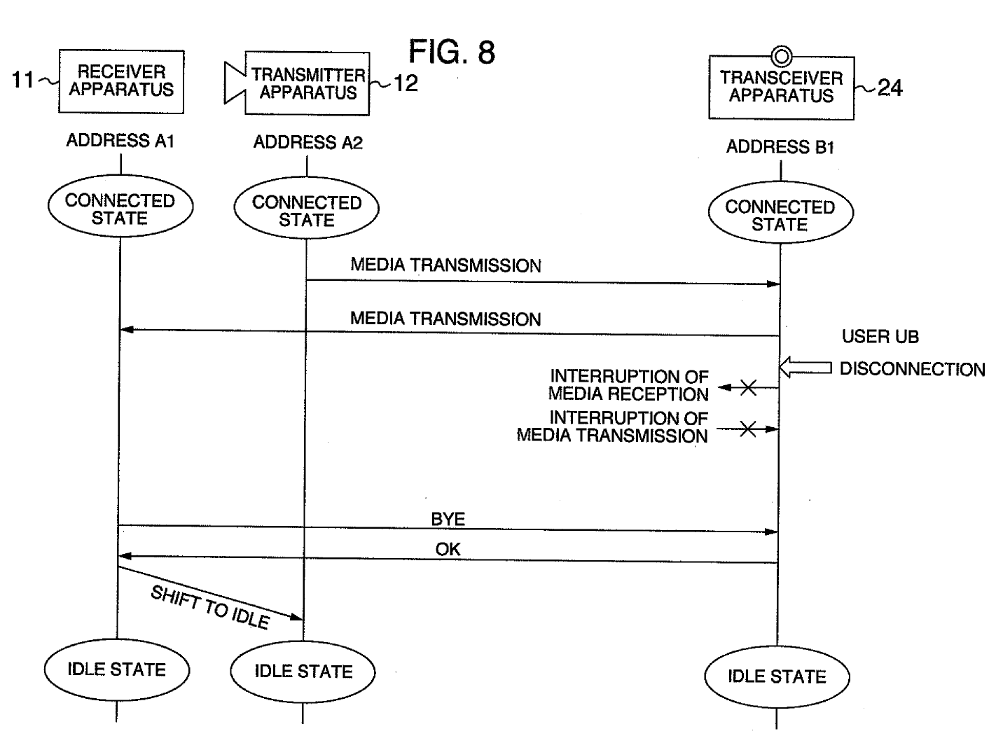

Next, a procedure in accordance with this embodiment for disconnecting a session from the site B (a case where the communication disconnecting operation is performed in the site B) will be explained below referring to FIG. 8. The process shown in FIG. 8 is implemented by the control of the components of the receiver apparatus 11 by its control unit 115, the control of the components of the transmitter apparatus 12 by its control unit 125 and the control of the components of the transceiver apparatus 24 by its control unit 115.

In FIG. 8, a session has already been started and each apparatus (11, 12, 24) is in the CONNECTED state. At this point, the user UB of the site B performs the communication disconnecting operation on the transceiver apparatus 24.

In response to the operation by the user UB, the transceiver apparatus 24 interrupts the media data reception from the transmitter apparatus 12 and the media data transmission to the receiver apparatus 11 while also transmitting the BYE message (requesting the disconnection of the session) to the receiver apparatus 11. Incidentally, the transceiver apparatus 24 may also be configured to execute the interruption of the media data reception, the interruption of the media data transmission and the transmission of the BYE message to the receiver apparatus 11 in a different order or at the same time.

Upon reception of the BYE message from the transceiver apparatus 24, the receiver apparatus 11 shifts to the IDLE state and instructs the transmitter apparatus 12 to shift to the IDLE state.

In response to the instruction (to shift to the IDLE state) from the receiver apparatus 11, the transmitter apparatus 12 shifts to the IDLE state.

Further, the receiver apparatus 11 transmits the OK message (acknowledging the disconnection) to the transceiver apparatus 24. The receiver apparatus 11 may also be configured to execute the shifting to the IDLE state, the instruction to the transmitter apparatus 12 to shift to the IDLE state and the transmission of the OK message to the transceiver apparatus 24 in a different order or at the same time.

Upon reception of the OK message from the receiver apparatus 11, the transceiver apparatus 24 shifts to the IDLE state.

As described above, with the second embodiment, effects similar to those of the first embodiment may be achieved even when both the functions of transmitting and receiving media data are implemented by a single apparatus (transceiver apparatus) in one of the sites and a single address (B1) has been assigned to the transceiver apparatus.

### Embodiment 3

In the following, a third embodiment in accordance with the present invention will be described in detail. In this embodiment, each site (A, B) is made up of the same apparatuses as those in the first embodiment (as shown in FIG. 2). In the following description of the third embodiment, explanation of elements similar to those in the first embodiment will be omitted for brevity.

The third embodiment differs from the first embodiment in that the media data transmission after the establishment of the connection is executed by the transmitter apparatus (12, 22) of each site (A, B) in response to a request from the receiver apparatus (21, 11) of the opposite site (B, A).

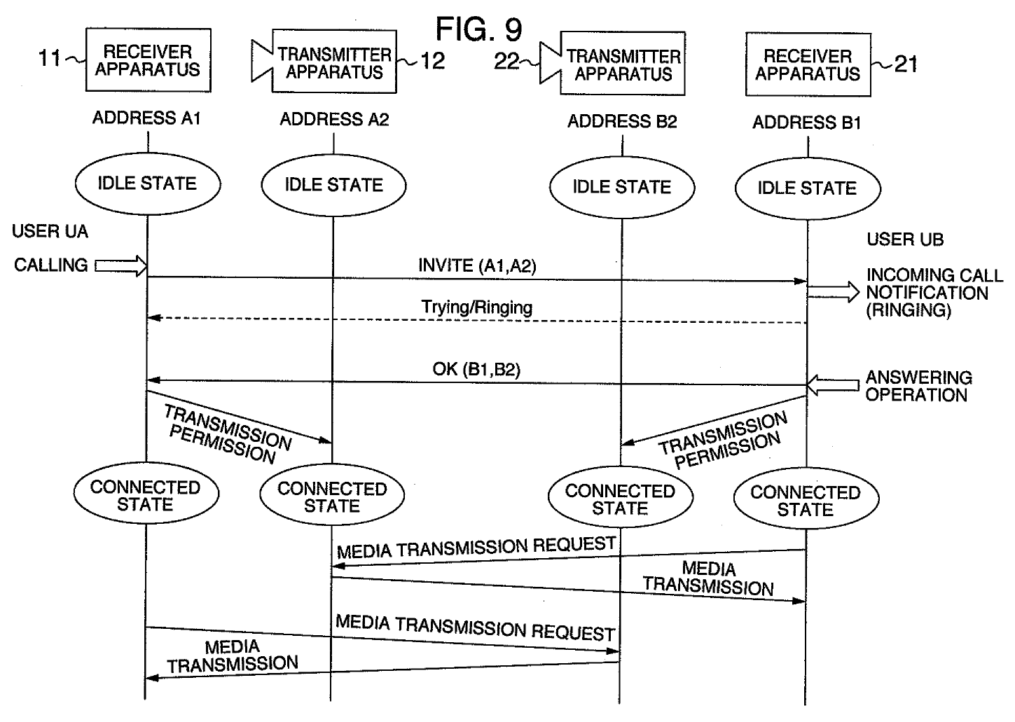

A procedure for starting a session in accordance with this embodiment will be explained below referring to FIG. 9, wherein the sites A and B are assumed to operate as a calling end (caller) and a receiving end (callee), respectively. The process shown in FIG. 9 is implemented by the control of the components of each receiver apparatus (11, 21) by its control unit 115 and the control of the components of each transmitter apparatus (12, 22) by its control unit 125.

Before starting communication, each apparatus (11, 12, 21, 22) is in the IDLE state (standby state).

The user UA of the site A performs the calling operation on the receiver apparatus 11 (TV) by specifying the address B1 as the destination of the call (callee). In response to the user UA's calling operation, the receiver apparatus 11 of the site A transmits the INVITE message (requesting starting of communication) to the receiver apparatus 21 of the site B. The INVITE message sent from the receiver apparatus 11 contains address information (A1) on the receiver apparatus 11 as the recipient address (address of the recipient of media data in the site A (caller)) and the address (A2) of the transmitter apparatus 12 as the sender address (address of the sender of media data in the site A).

The receiver apparatus 21 of the site B receives the INVITE message and thereby recognizes the communication start request from the site A. In response to the request, the receiver apparatus 21 notifies the site B's user UB of the incoming call and prompts the user UB to answer the call, by making a sound, displaying information on its screen, etc.

At this point, the receiver apparatus 21 may also transmit the TRYING message or RINGING message (indicating that the receiver apparatus 21 is ringing) to the receiver apparatus 11. In this case, the receiver apparatus 11 receiving the TRYING or RINGING message may inform the user UA that the receiver apparatus 11 is making a call (by making a sound, displaying information on its screen, etc.).

When the user UB of the site B permits the call reception by performing the answering operation, the receiver apparatus 21 shifts to the CONNECTED state and transmits the OK message (acknowledging the call reception) to the receiver apparatus 11. The OK message sent from the receiver apparatus 21 contains address information (B1) on the receiver apparatus 21 as the recipient address (address of the recipient of media data in the site B (callee)) and the address (B2) of the transmitter apparatus 22 as the sender address (address of the sender of media data in the site B).

Further, the receiver apparatus 21 issues a transmission permitting instruction (instruction permitting the transmission of media data) to the transmitter apparatus 22. Incidentally, the receiver apparatus 21 may also be configured to execute the transmission of the OK message to the receiver apparatus 11 and the issuance of the transmission permitting instruction to the transmitter apparatus 22 in a different order or at the same time.

Upon reception of the OK message from the receiver apparatus 21, the receiver apparatus 11 shifts to the CONNECTED state and issues the transmission permitting instruction (instruction permitting the transmission of media data) to the transmitter apparatus 12. The receiver apparatus 11 may also be configured to execute the shifting to the CONNECTED state and the issuance of the transmission permitting instruction to the transmitter apparatus 12 in a different order or at the same time.

In response to the media data transmission permitting instruction from the receiver apparatus 11, the transmitter apparatus 12 shifts to the CONNECTED state.

Meanwhile, the receiver apparatus 21 transmits a media data transmission request to the address A2 of the transmitter apparatus 12 contained in the aforementioned INVITE message.

Upon reception of the media data transmission request (after the shift to the CONNECTED state) from the receiver apparatus 21, the transmitter apparatus 12 captures video and sound (voice) with its built-in camera and microphone and starts transmitting encoded media data (obtained by encoding the captured video and sound) to the receiver apparatus 21.

The receiver apparatus 21 receives the media data transmitted from the transmitter apparatus 12 and outputs video and sound (voice) obtained by decoding the received media data.

Meanwhile, the transmitter apparatus 22 receiving the media data transmission permitting instruction from the receiver apparatus 21 also shifts to the CONNECTED state.

The receiver apparatus 11 transmits the media data transmission request to the address B2 of the transmitter apparatus 22 contained in the aforementioned OK message.

Upon reception of the media data transmission request (after the shift to the CONNECTED state) from the receiver apparatus 11, the transmitter apparatus 22 captures video and sound (voice) with its built-in camera and microphone and starts transmitting encoded media data (obtained by encoding the captured video and sound) to the receiver apparatus 11.

The receiver apparatus 11 receives the media data transmitted from the transmitter apparatus 22 and outputs video and sound (voice) obtained by decoding the received media data.

Incidentally, while the media data transmission/reception between the transmitter apparatus 22 and the receiver apparatus 11 is started after the start of the media data transmission/reception between the transmitter apparatus 12 and the receiver apparatus 21 in the example of FIG. 9, the two media data transmission/reception processes may also be started in a different order or at the same time.

As described above, with the third embodiment, effects similar to those of the first embodiment may be achieved even when a protocol like HTTP (Hyper Text Transfer Protocol) is used, that is, even when the media data transmission after the connection establishment is executed by the transmitter apparatus (12, 22) of each site (A, B) in response to a request from the receiver apparatus (21, 11) of the opposite site (B, A).

### Embodiment 4

In the following, a fourth embodiment in accordance with the present invention will be described in detail. In this embodiment, each site (A, B) is made up of the same apparatuses as those in the third (first) embodiment (as shown in FIG. 2). Similarly to the third embodiment, the media data transmission after the connection establishment is executed by the transmitter apparatus (12, 22) of each site (A, B) in response to a request from the receiver apparatus (21, 11) of the opposite site (B, A). In the following description of the fourth embodiment, explanation of elements similar to those in the third embodiment will be omitted for brevity.

The fourth embodiment differs from the third embodiment in that the INVITE message is sent out not by the receiver apparatus 11 but by the transmitter apparatus 12.

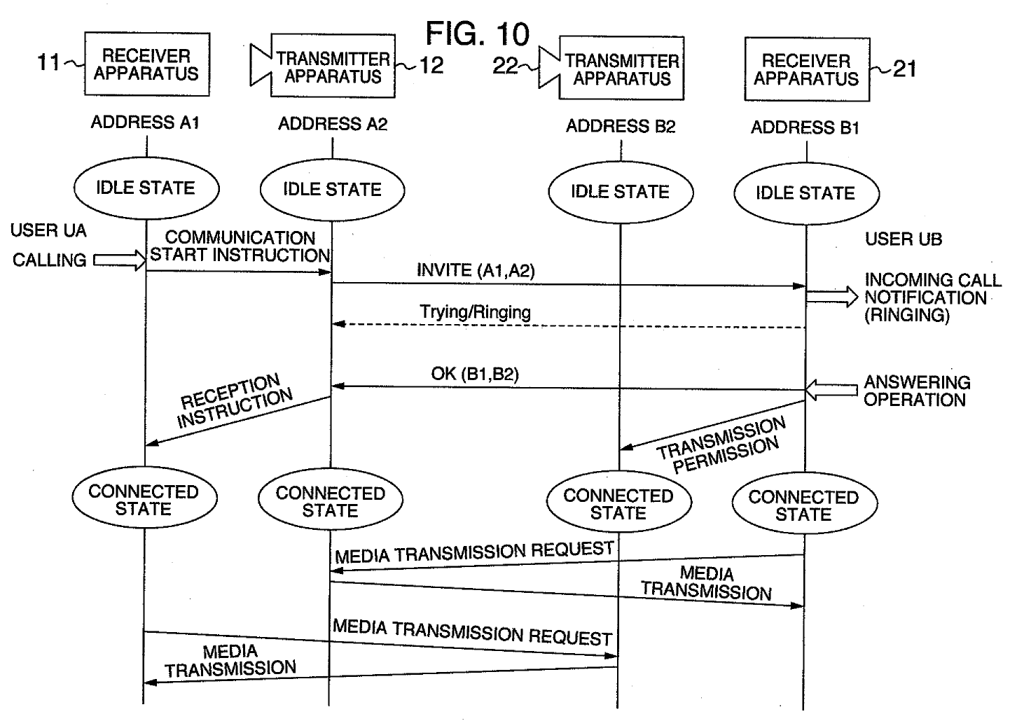

A procedure for starting a session in accordance with this embodiment will be explained below referring to FIG. 10, wherein the sites A and B are assumed to operate as a calling end (caller) and a receiving end (callee), respectively. The process shown in FIG. 10 is implemented by the control of the components of each receiver apparatus (11, 21) by its control unit 115 and the control of the components of each transmitter apparatus (12, 22) by its control unit 125.

Before starting communication, each apparatus (11, 12, 21, 22) is in the IDLE state (standby state).

The user UA of the site A performs the calling operation on the receiver apparatus 11 (e.g. TV set) by specifying the address B1 as the destination of the call (callee).

In response to the user UA's calling operation, the receiver apparatus 11 issues a communication start instruction to the transmitter apparatus 12. The communication start instruction issued by the receiver apparatus 11 contains the address information (B1) on the receiver apparatus 21 (callee).

In response to the communication start instruction, the transmitter apparatus 12 transmits the INVITE message (requesting starting of communication) to the receiver apparatus 21. The INVITE message sent from the transmitter apparatus 12 contains the address information (A1) on the receiver apparatus 11 as the recipient address (address of the recipient of media data in the site A (caller)) and the address (A2) of the transmitter apparatus 12 as the sender address (address of the sender of media data in the site A).

The receiver apparatus 21 of the site B receives the INVITE message and thereby recognizes the communication start request from the site A. In response to the request, the receiver apparatus 21 notifies the site B's user UB of the incoming call and prompts the user UB to answer the call, by making a sound, displaying information on its screen, etc.

At this point, the receiver apparatus 21 may also transmit the TRYING message or RINGING message (indicating that the receiver apparatus 21 is ringing) to the transmitter apparatus 12. In this case, the transmitter apparatus 12 receiving the TRYING or RINGING message (or the receiver apparatus 11 informed of the reception of the TRYING or RINGING message by the transmitter apparatus 12) may inform the user UA that the receiver apparatus 11 is making a call (by making a sound, displaying information on its screen, etc.).

When the user UB of the site B permits the call reception by performing the answering operation, the receiver apparatus 21 shifts to the CONNECTED state and transmits the OK message (acknowledging the call reception) to the transmitter apparatus 12. The OK message sent from the receiver apparatus 21 contains the address information (B1) on the receiver apparatus 21 as the recipient address (address of the recipient of media data in the site B (callee)) and the address (B2) of the transmitter apparatus 22 as the sender address (address of the sender of media data in the site B).

Further, the receiver apparatus 21 issues the transmission permitting instruction (instruction permitting the transmission of media data) to the transmitter apparatus 22. Incidentally, the receiver apparatus 21 may also be configured to execute the shifting to the CONNECTED state, the transmission of the OK message to the transmitter apparatus 12 and the issuance of the transmission permitting instruction to the transmitter apparatus 22 in a different order or at the same time.

Upon reception of the OK message from the receiver apparatus 21, the transmitter apparatus 12 shifts to the CONNECTED state and issues a reception instruction (instruction for receiving media data) to the receiver apparatus 11. The reception instruction issued by the transmitter apparatus 12 contains the address information (B2) on the transmitter apparatus 22 as the sender of the media data. Incidentally, the transmitter apparatus 12 may also be configured to execute the shifting to the CONNECTED state and the issuance of the reception instruction to the receiver apparatus 11 in a different order or at the same time.

In response to the media data reception instruction from the transmitter apparatus 12, the receiver apparatus 11 shifts to the CONNECTED state.

Meanwhile, the receiver apparatus 21 transmits the media data transmission request to the address A2 of the transmitter apparatus 12 contained in the aforementioned INVITE message.

Upon reception of the media data transmission request (after the shift to the CONNECTED state) from the receiver apparatus 21, the transmitter apparatus 12 captures video and sound (voice) with its built-in camera and microphone and starts transmitting encoded media data (obtained by encoding the captured video and sound) to the receiver apparatus 21.

The receiver apparatus 21 receives the media data transmitted from the transmitter apparatus 12 and outputs video and sound (voice) obtained by decoding the received media data.

Meanwhile, the transmitter apparatus 22 receiving the media data transmission permitting instruction from the receiver apparatus 21 shifts to the CONNECTED state.

The receiver apparatus 11 transmits the media data transmission request to the address B2 of the transmitter apparatus 22 contained in the aforementioned reception instruction.

Upon reception of the media data transmission request (after the shift to the CONNECTED state) from the receiver apparatus 11, the transmitter apparatus 22 captures video and sound (voice) with its built-in camera and microphone and starts transmitting encoded media data (obtained by encoding the captured video and sound) to the receiver apparatus 11.

The receiver apparatus 11 receives the media data transmitted from the transmitter apparatus 22 and outputs video and sound (voice) obtained by decoding the received media data.

Incidentally, while the media data transmission/reception between the transmitter apparatus 22 and the receiver apparatus 11 is started after the start of the media data transmission/reception between the transmitter apparatus 12 and the receiver apparatus 21 in the example of FIG. 10, the two media data transmission/reception processes may also be started in a different order or at the same time.

As described above, effects similar to those of the third embodiment may be achieved also with the fourth embodiment.

It should be further understood by those skilled in the art that although the foregoing description has been on embodiments of the invention, the invention is not limited thereto and various changes and modifications may be made without departing from the spirit of the invention and the scope of the appended claims.

1. A receiver apparatus for receiving image data and audio data via a network, comprising:
a decoding unit which decodes received image data and audio data;
an image output unit which outputs the image data decoded by the decoding unit;
an audio output unit which outputs the audio data decoded by the decoding unit;
a recording unit which records an address of a transmitter apparatus that has been associated with the receiver apparatus; and
a control unit which instructs the transmitter apparatus associated with the receiver apparatus to transmit data to an address of a different receiver apparatus when the address of the different receiver apparatus is received.

2. The receiver apparatus according to claim 1, wherein the transmitter apparatus encodes images captured by a camera unit and transmits data obtained by the encoding of the images to the address of the different receiver apparatus in response to the instruction for transmitting the data.

3. The receiver apparatus according to claim 1, wherein the receiver apparatus instructs the transmitter apparatus to stop the data transmission and transmits information requesting disconnection of a session to the different receiver apparatus when an instruction for interrupting data reception is received.

4. The receiver apparatus according to claim 1, further comprising a display which displays the image data output from the image output unit.

5. The receiver apparatus according to claim 1, further comprising a speaker which reproduces the audio data output from the audio output unit.

6. A transmission/reception system in which a first receiver apparatus, a first transmitter apparatus which has been associated with the first receiver apparatus, a second receiver apparatus and a second transmitter apparatus which has been associated with the second receiver apparatus are connected together by a network, wherein:
each of the first and second receiver apparatuses includes:
a decoding unit which decodes received image data and audio data;
an image output unit which outputs the image data decoded by the decoding unit;
an audio output unit which outputs the audio data decoded by the decoding unit;
a recording unit which records an address of the transmitter apparatus associated with the receiver apparatus; and
a control unit which controls the receiver apparatus, and
each of the first and second transmitter apparatuses includes:
an encoding unit which encodes images and sound; and
a control unit which controls the transmitter apparatus, and
the control unit of the second receiver apparatus transmits an address of the second receiver apparatus to the first receiver apparatus when an address of the first receiver apparatus is received by the second receiver apparatus, and
the control unit of the first receiver apparatus receiving the address of the second receiver apparatus instructs the first transmitter apparatus to transmit image data and audio data to the address of the second receiver apparatus, and
the first transmitter apparatus receiving the instruction from the control unit of the first receiver apparatus transmits image data and audio data obtained by the encoding by the encoding unit of the first transmitter apparatus to the second receiver apparatus, and
the control unit of the second receiver apparatus instructs the second transmitter apparatus to transmit image data and audio data to the address of the first receiver apparatus received from the first receiver apparatus, and
the second transmitter apparatus receiving the instruction from the control unit of the second receiver apparatus transmits image data and audio data obtained by the encoding by the encoding unit of the second transmitter apparatus to the first receiver apparatus.

7. The transmission/reception system according to claim 6, wherein the first receiver apparatus instructs the first transmitter apparatus to stop the data transmission and transmits information requesting disconnection of a session to the second receiver apparatus when an instruction for interrupting data reception is received.

8. The transmission/reception system according to claim 7, wherein the second receiver apparatus receiving the information requesting the disconnection of the session from the first receiver apparatus instructs the second transmitter apparatus to shift to an IDOL state.

9. The transmission/reception system according to claim 6, wherein each of the first and second receiver apparatuses further includes a display which displays the image data output from the image output unit.

10. The transmission/reception system according to claim 6, wherein each of the first and second receiver apparatuses further includes a speaker which reproduces the audio data output from the audio output unit.

11. A reception method for a receiver apparatus for receiving image data and audio data via a network, comprising the steps of:
transmitting an address of the receiver apparatus to a second receiver apparatus;
receiving an address of the second receiver apparatus from the second receiver apparatus;
instructing a first transmitter apparatus which has been associated with the receiver apparatus to transmit image data and audio data to the received address of the second receiver apparatus; and
decoding image data and audio data transmitted from a second transmitter apparatus which has been associated with the second receiver apparatus.

12. The reception method according to claim 11, wherein the first transmitter apparatus encodes images captured by a camera unit and transmits data obtained by the encoding of the images to the address of the second receiver apparatus in response to the instruction for transmitting the data.

13. The reception method according to claim 11, wherein the receiver apparatus instructs the first transmitter apparatus to stop the data transmission and transmits information requesting disconnection of a session to the second receiver apparatus when an instruction for interrupting data reception is received.

14. The reception method according to claim 11, wherein the decoded image data is displayed by a display.

15. The reception method according to claim 11, wherein the decoded audio data is played back by a speaker.
